(19) United States
(12) Patent Application Publication
(10) Pub. No.: US 2021/0389165 A1
(43) Pub. Date: Dec. 16, 2021

(54) CORIOLIS MEASURING TRANSDUCER, AND CORIOLIS MEASURING DEVICE

(71) Applicant: Endress+Hauser Flowtec AG, Reinach (CH)

(72) Inventors: Severin Ramseyer, Münchenstein (CH); Benjamin Schwenter, Breitenbach (CH)

(21) Appl. No.: 16/967,097

(22) PCT Filed: Jan. 23, 2019
(86) PCT No.: PCT/EP2019/051603

§ 371 Date: Aug. 3, 2020

(30) Foreign Application Priority Data
Feb. 2, 2018 (DE) 10 2018 102 379.0

(51) Int. Cl. G01F 1/84

(52) U.S. Cl. CPC G01F 1/8472; G01F 1/8427; G01F 1/8431; G01F 1/8422

(57) ABSTRACT

The invention relates to a Coriolis measuring transducer (10) of a Coriolis measuring device (1) as well as to the Coriolis measuring device for registering a mass flow or a density of a medium flowing through at least one measuring tube of the Coriolis measuring device, comprising:

the at least one measuring tube (11) having an inlet (11.1) and an outlet (11.2) and adapted to convey the medium between the inlet and outlet;
at least one exciter (12), which is adapted to excite the at least one measuring tube to execute oscillations;
at least one sensor (13), which is adapted to register deflection of the oscillations of the at least one measuring tube;
wherein at least one exciter as well as at least one sensor have, in each case, a coil apparatus (14) with, in each case, at least one coil (14.1) as well as, in each case, a magnet apparatus (15), wherein the magnet apparatus and the coil apparatus are movable relative to one another,
characterized in that at least one exciter or at least one sensor has an integrated temperature measuring device (14.3) for measuring temperature of the exciter, or of the sensor, as the case may be.

The invention relates to a Coriolis measuring transducer and to a Coriolis measuring device having a temperature measuring device integrated in a sensor or in an exciter.

Coriolis measuring devices utilize the fact that an oscillation impressed on an oscillation tube is modified as a function of a flow of a medium through the oscillation tube in a characteristic manner compared with an oscillation without flow.

The impressing and registering of these oscillations is accomplished by means of exciters and sensors, respectively. Since the oscillatory behavior of the oscillation tube is also influenced by its temperature and temperature distribution, additional, temperature sensors are applied, which register the temperature, or temperature distribution; see, for example, DE102015120087A1.

The arranging of additional temperature sensors increases the complexity of the manufacture and the susceptibility to failure of Coriolis measuring devices.

An object of the invention is, consequently, to provide a Coriolis measuring transducer as well as a Coriolis flow measuring device, in the case of which temperature sensors are integrated in a robust manner.

The object is achieved by a Coriolis measuring transducer as defined in independent claim 1 as well as by a Coriolis measuring device as defined in independent claim 15.

A Coriolis measuring transducer of the invention for a Coriolis measuring device for registering a mass flow or a density of a medium flowing through at least one measuring tube of the Coriolis measuring device comprises:

the at least one measuring tube having an inlet and an outlet and adapted to convey the medium between the inlet and outlet;
at least one exciter, which is adapted to excite the at least one measuring tube to execute oscillations;
at least one sensor, which is adapted to register deflection of the oscillations of the at least one measuring tube;
wherein at least one exciter as well as at least one sensor have, in each case, a coil apparatus with, in each case, at least one coil as well as, in each case, a magnet apparatus, wherein the magnet apparatus and the coil apparatus are movable relative to one another,
wherein at least one exciter or at least one sensor has an integrated temperature measuring device, which is adapted to make the temperature of the exciter, or of the sensor, measurable.

Because of the integrated temperature measuring device, an electrical connection of the temperature measuring device with the electronic measuring/operating circuit can be arranged in a connecting cable, in which also an electrical connection of the exciter, or sensor, is arranged. In this way, cable in the measuring transducer can be saved and the temperature, or a temperature distribution, of an oscillation tube registered by means of the at least one exciter, or sensor.

In an embodiment, the coil apparatus includes a printed circuit board having at least one printed circuit board layer, wherein the coil is applied on at least a first face of a printed circuit board layer, and wherein the temperature measuring device has a resistance measuring section of an electrically conductive material, which is applied on at least a first face and/or on at least a second face other than the first face of a printed circuit board layer.

For example, the printed circuit board or the magnet apparatus can be secured to the measuring tube, wherein the magnet apparatus, or the printed circuit board, is translationally and rotationally fixed, or mounted on a second measuring tube or counteroscillation apparatus. In the former case, the printed circuit board registers the temperature of the measuring tube directly, while in the second case the printed circuit board registers the temperature of the measuring tube at least partially indirectly via heat radiation from the magnet apparatus. In the case of a translational and rotationally fixed magnet apparatus, or printed circuit board, the magnet apparatus, or the printed circuit board, can, for example, be secured via a support tube of the Coriolis measuring device, wherein eigenfrequencies of the support tube differ from eigenfrequencies of the measuring tube and, thus, no oscillatory coupling takes place.

In an embodiment, the printed circuit board is a multilayer printed circuit board and comprises a plurality of printed circuit board layers, which are stacked and connected with neighboring printed circuit board layers via their faces,

wherein the coil has a plurality of subcoils and two coil contacts, which subcoils are arranged on different first faces, wherein coil contacts are arranged at ends of the coil, and wherein the printed circuit board has first vias, which are adapted to connect adjoining subcoils electrically with one another,
wherein the resistance measuring section has at least two measuring section contacts.

Because of the use of a multilayer printed circuit board, a coil can have, as compared with a printed circuit board composed of one printed circuit board layer, a greater inductance, a feature which significantly improves exciter-, or sensor, power.

In an embodiment, the resistance measuring section has an inductance, which is at least 10 times and, especially, at least 50 times and preferably at least 200 times, less than an inductance of the coil. In this way, mutual influencing of coil and resistance measuring section can be minimized, this meaning, thus, improved exciter-, or sensor, power.

In an embodiment, a first part of the resistance measuring section is arranged on a first face or a second face, wherein the first part is embodied meander shaped at least in certain regions. In this way, the inductance of the resistance measuring section can be decreased and a resistance of the resistance measuring section optimized, in order to increase accuracy of measurement.

In an embodiment, the magnet apparatus comprises at least one permanent magnet, which has at least one region, which is offset relative to the coil in the direction of a coil axis. In this way, the permanent magnet can be moved perpendicularly, or in parallel with the coil axis, in order to induce an electrical voltage in the coil, or exert a force by means of a magnetic field produced via the coil.

In an embodiment, the coil and/or the resistance measuring section are produced on the corresponding faces by means of etching.

In an embodiment, conductive traces defining the coil, and the resistance measuring section, have a width of less than 200 micrometer and especially less than 100 micrometer and preferably less than 70 micrometer. A lessening of the width of the conductive traces enables increasing lengths of the coil and the resistance measuring section. In this way, more flexibility is present for optimizing the inductance of the coil and the resistance of the resistance measuring section.

In an embodiment, at least one exciter and at least one sensor or at least two exciters or at least two sensors of a measuring tube have integrated temperature measuring devices,

whereby a spatial temperature distribution of the measuring tube is determinable, in order that an oscillatory behavior of the corresponding measuring tube is determinable.

Knowledge of temperature enables correction of a flow- or density determination of the medium flowing through the measuring tube.

In an embodiment, the flow measuring device includes a support tube having a support tube chamber, which is adapted at least sectionally to house the at least one measuring tube.

In an embodiment, the coil of an exciter is adapted to exert a force on the associated magnet apparatus, and wherein the magnet apparatus of a sensor is adapted to induce in the coil of the associated coil apparatus an electrical voltage.

In an embodiment, each measuring tube is at least sectionally bent, and wherein the bend of each measuring tube defines a plane in a resting state of the measuring tube;

wherein the at least one exciter is adapted to excite the measuring tube to execute oscillations by means of deflection of the bend of the measuring tube perpendicularly to the plane.

In an embodiment, the measuring transducer includes two manifolds, wherein a first manifold on an upstream end of the measuring transducer is adapted to receive a medium flowing from a pipeline into the measuring transducer and to convey such to the inlet of the at least one measuring tube,

wherein a second manifold is adapted to receive the medium exiting from the outlet of the at least one measuring tube and to convey such back into the pipeline.

In an embodiment, the measuring transducer includes two process connections, especially flanges, which are adapted to connect the measuring transducer into a pipeline.

In an embodiment, the magnet apparatus is mechanically connected with the associated measuring tube, and wherein the coil is translationally as well as rotationally fixed relative to the inlet, and outlet.

A Coriolis measuring device of the invention comprises:

a Coriolis measuring transducer as defined in one of the above versions;
an electronic measuring/operating circuit, wherein the electronic measuring/operating circuit is adapted electrically to supply the coils and, in given cases, associated temperature measuring device, wherein the supplying of the coil as well as the temperature measuring device is accomplished by means of separate electrical connections or by means of multiplexing,
wherein the at least one electrical connection of a sensor, or exciter, extends by means of a cable path to the electronic measuring/operating circuit,
wherein the electronic measuring/operating circuit is further adapted to ascertain and to provide flow measured values and/or density measurement values.

The invention will now be described based on examples of embodiments presented in the appended drawing, the figures of which show as follows:

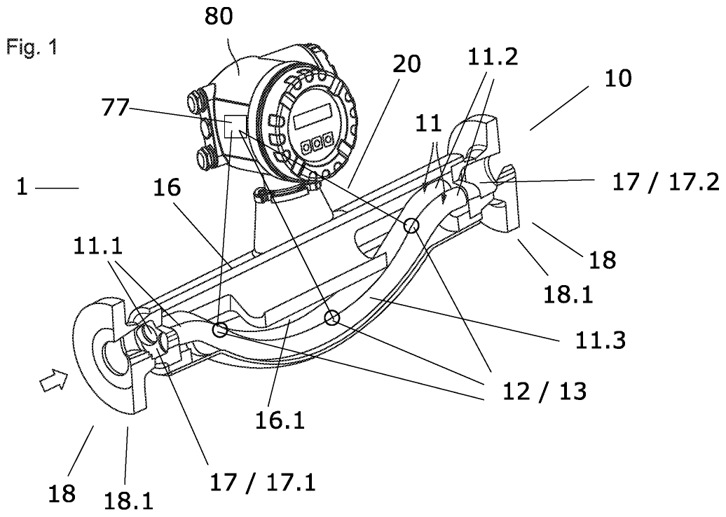

FIG. 1 by way of example, a Coriolis measuring device having an example of a Coriolis measuring transducer comprising an exciter and sensors of the invention;

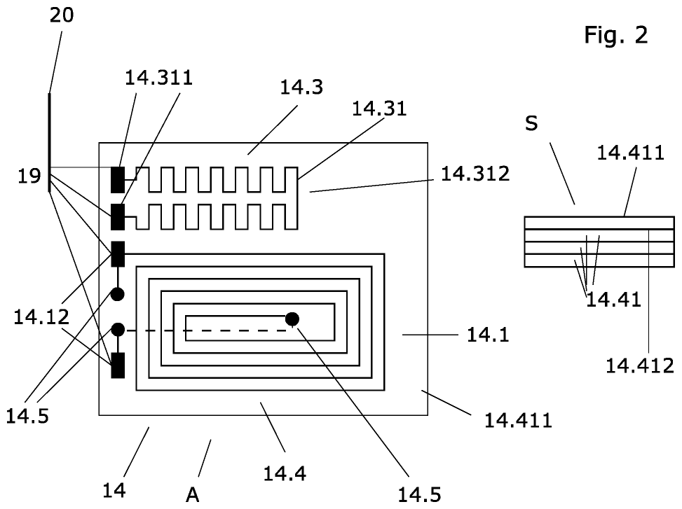

FIG. 2 a schematic plan view of a printed circuit board of an example of an exciter, or sensor, of the invention, and

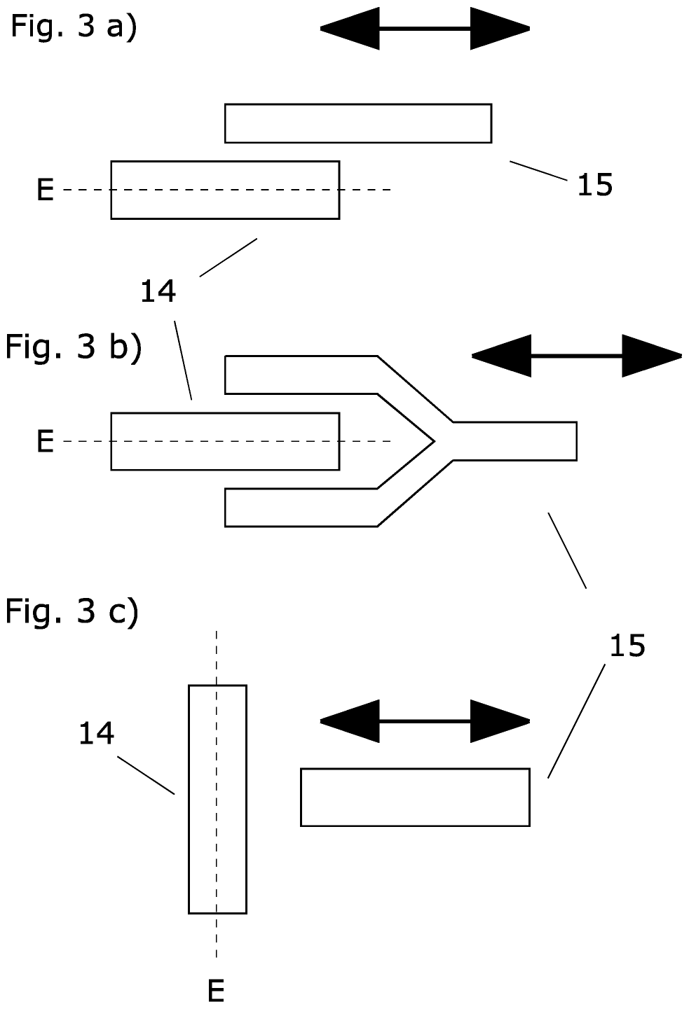

FIGS. 3a) to 3c) schematic views of examples of embodiments of an exciter, or sensor, of the invention.

FIG. 1 shows a Coriolis measuring device 1 for measuring flow or density of a medium flowing through a measuring tube 11 of the measuring device, comprising a measuring transducer 10 and, connected to the measuring transducer, an electronics housing 80, in which an electronic measuring/operating circuit 77 is arranged for operating exciters 12 and sensors 13 and for providing flow- and/or density measurement values of the medium. Measuring transducer 10 includes a support tube 15 having a support tube chamber 15.1, in which two measuring tubes 11 are arranged. The support tube includes process connections 17, especially in the form of flanges 17.1, on its ends, by means of which process connections 17 the Coriolis measuring device can be integrated into a pipeline (not shown). In the region of the process connections, the measuring transducer 10 includes, in each case, a manifold 16, here a Y-piece, wherein a manifold 16 pointing upstream is adapted to receive a medium incoming from the pipeline into the measuring transducer and to distribute it uniformly to the inlets 11.1 of the two measuring tubes. A downstream pointing, second manifold 16.2 is adapted to receive the medium flowing out from the outlets 11.2 of the measuring tubes and to return such back into the pipeline. At least one exciter 12 and at least one sensor 13 are provided to excite the measuring tubes 11 to execute oscillations and to register the oscillations, respectively. Alternatively to the embodiment of the Coriolis measuring device shown here, the measuring device can also have only one measuring tube or even four measuring tubes, wherein the measuring tubes can be housed, for example, also only in part of the support tube chamber 15.1. Embodiments with bent measuring tubes, such as shown here, provide one option and embodiments with straight measuring tubes are another option. At least one exciter as well as at least one sensor have, in each case, a coil apparatus 14 (see FIG. 2) with, in each case, at least one coil 14.1 as well as, in each case, a magnet apparatus 14.2 (see FIGS. 3 a) to c)), wherein the magnet apparatus and the coil apparatus are movable relative to one another. The coil apparatus and the magnet apparatus of a sensor are, in such case, then arranged in the measuring transducer such that oscillations of the at least one measuring tube bring about a relative movement between coil apparatus and magnet apparatus. An induced electrical voltage caused thereby can be registered as measuring signal and evaluated by the electronic measuring/operating circuit 77. In the case of an exciter, in contrast, applying an electrical voltage to the coil effects a force between coil apparatus and magnet apparatus, which is utilized for exciting a measuring tube oscillation. By providing at least one sensor 12 or exciter 13 of the invention (see FIG. 2 and FIGS. 3 a) to c)), the temperature of at least one measuring tube can be determined by means of the sensor, or exciter, in order in this way to ascertain oscillation characteristics of the measuring tube, wherein less cable is needed for producing electrical connections between an electronic measuring/operating circuit 77 and sensor, or exciter. By providing a plurality of elements of the invention, wherein an element is a sensor or an exciter, a spatial temperature distribution of at least one measuring tube can be registered and, thus, further details of the oscillation characteristics of the measuring tube can be registered.

FIG. 2 shows a schematic plan view A as well as, at reduced scale, a schematic, side view S of a coil apparatus of the invention 14 having a printed circuit board 14.4, which has a coil 14.1. The printed circuit board includes, in such case, a plurality of printed circuit board layers 14.41 with, in each case, a first face 14.411 and a second face 14.412. The coil comprises a plurality of subcoils 14.11, which are arranged on different faces and electrically connected by means of vias 14.5. The coil includes on its ends, in each case, coil contacts 14.12, by means of which the coil is contactable with the electronic measuring/operating circuit via electrical connections 19. As shown here, a coil contact can be connected with a via 14.5, in order to produce an electrical contacting of an end of a subcoil. Besides the coil 14.1, the printed circuit board 14.4 of the invention includes an integrated temperature measuring device 14.3, which, such as shown here, can be a resistance measuring section 14.31 with measuring section contacts 14.311. Equivalently to the coil contacts, the measuring section contacts are adapted to connect the electronic measuring/operating circuit with the resistance measuring section via electrical connections 19. The resistance measuring section can, such as shown here, be arranged on only one face, or, as in the case of the coil, extend over a plurality of faces. The resistance measuring section is, in such case, advantageously, meandering, in order to reduce an inductance of the resistance measuring section, and, thus, to reduce an influencing of the coil. Alternatively to the embodiment shown here, the printed circuit board can also have only one layer and/or the coil can be arranged on only one face. The electrical connections 19 are, in such case, advantageously combined in one cable path 20.

FIGS. 3 a) to c) show schematically by way of example manners of movement of the coil apparatus 14 and the magnet apparatus 15 relative to one another. For example, such as shown in the example of an embodiment illustrated in a) and b), the magnet apparatus 15 can be movable in parallel with a plane E parallel to the faces of the printed circuit board. The magnet apparatus can, in such case, sectionally adjoin both a top face and a bottom face of the printed circuit board, as shown in b). The magnet apparatus can also be movable perpendicularly to the plane E, see c).

### LIST OF REFERENCE CHARACTERS

1 Coriolis measuring device
10 Coriolis measuring transducer
11 measuring tube
11.1 inlet
11.2 outlet
11.3 bend
12 exciter
13 sensor
14 coil apparatus
14.1 coil
14.11 subcoil
14.12 coil contact
14.3 integrated temperature measuring device
14.31 resistance measuring section
14.311 measuring section contact
14.312 first part of the resistance measuring section
14.4 printed circuit board
14.41 printed circuit board layer
14.411 first face
14.412 second face
14.5 via
15 magnet apparatus
15.1 permanent magnet
16 support tube
16.1 support tube chamber
17 manifold
17.1 first manifold
17.2 second manifold
18 process connection
18.1 flange
19 electrical connections
20 cable path
77 electronic measuring/operating circuit
80 electronics housing
A plan view
S side view

1. Coriolis measuring transducer (10) for a Coriolis measuring device (1) for registering a mass flow or a density of a medium flowing through at least one measuring tube of the Coriolis measuring device, comprising:
the at least one measuring tube (11) having an inlet (11.1) and an outlet (11.2) and adapted to convey the medium between the inlet and outlet;
at least one exciter (12), which is adapted to excite the at least one measuring tube to execute oscillations;
at least one sensor (13), which is adapted to register deflection of the oscillations of the at least one measuring tube;
wherein at least one exciter as well as at least one sensor have, in each case, a coil apparatus (14) with, in each case, at least one coil (14.1), as well as, in each case, a magnet apparatus (14.2), wherein the magnet apparatus and the coil apparatus are movable relative to one another,
characterized in that at least one exciter or at least one sensor has an integrated temperature measuring device (14.3) for measuring temperature of the exciter, or of the sensor, as the case may be.

2. Coriolis measuring transducer as claimed in claim 1,
wherein the coil apparatus includes a printed circuit board (14.4) having at least one printed circuit board layer (14.41), wherein the coil is applied on at least a first face (14.411) of a printed circuit board layer, and
wherein the temperature measuring device has a resistance measuring section (14.31) of an electrically conductive material, which is applied on at least a first face and/or on at least a second face (14.411, 14.412) other than the first face of a printed circuit board layer.

3. Coriolis measuring transducer as claimed in claim 2,
wherein the printed circuit board is a multilayer printed circuit board and comprises a plurality of printed circuit board layers (14.41), which are stacked and connected with neighboring printed circuit board layers via their faces,
wherein the coil has a plurality of subcoils (14.11) and two coil contacts (14.12), which subcoils are arranged on different first faces, wherein coil contacts (14.12) are arranged at ends of the coil, and wherein the printed circuit board has first vias (14.5), which are adapted to connect adjoining subcoils electrically with one another,
wherein the resistance measuring section has two measuring section contacts (14.311).

4. Coriolis measuring transducer as claimed in claim 2 or 3,
wherein the resistance measuring section (14.31) has an inductance, which is at least 10 times and, especially, at least 50 times and preferably at least 200 times, less than an inductance of the coil.

5. Coriolis measuring transducer as claimed in claim 4,
wherein a first part of the resistance measuring section (14.312) is arranged on a first face or a second face, wherein at least the first part is embodied meander shaped at least in certain regions.

6. Coriolis measuring transducer as claimed in one of the preceding claims,
wherein the magnet apparatus (14.2) comprises at least one permanent magnet (14.21), which has at least one region, which is offset relative to the coil in the direction of a coil axis.

7. Coriolis measuring transducer as claimed in one of claims 2 to 6,
wherein the coil and/or the resistance measuring section are produced on the corresponding faces especially by means of etching or printing or screen printing or photochemically.

8. Coriolis measuring transducer as claimed in one of claims 2 to 7,
wherein conductive traces defining the coil, and the resistance measuring section, have a width of less than 200 micrometer and, especially, less than 100 micrometer and preferably less than 70 micrometer.

9. Coriolis measuring transducer as claimed in one of the preceding claims,
wherein at least one exciter and at least one sensor or at least two exciters or at least two sensors of a measuring tube have integrated temperature measuring devices,
wherein a spatial temperature distribution of the measuring tube is determinable, in order that an oscillatory behavior of the corresponding measuring tube is determinable.

10. Coriolis measuring transducer as claimed in one of the preceding claims,
wherein the measuring transducer includes a support tube (16) having a support tube chamber (16.1), which is adapted at least sectionally to house the at least one measuring tube.

11. Coriolis measuring transducer as claimed in one of the preceding claims,
wherein the coil of an exciter is adapted to exert a force on the associated magnet apparatus, and wherein the magnet apparatus of a sensor is adapted to induce in the coil of the associated coil apparatus an electrical voltage.

12. Coriolis measuring transducer as claimed in one of the preceding claims,
wherein the measuring transducer includes two manifolds (17), wherein a first manifold (17.1) on an upstream end of the measuring transducer is adapted to receive a medium flowing from a pipeline into the measuring transducer and to convey such to the inlet of the at least one measuring tube,
wherein a second manifold (17.2) is adapted to receive medium flowing from the outlet of the at least one measuring tube and to convey such back into the pipeline.

13. Coriolis measuring transducer as claimed in one of the preceding claims,
wherein the measuring transducer includes two process connections (18), especially flanges (18.1), which are adapted to connect the measuring transducer into a pipeline.

14. Coriolis measuring transducer as claimed in one of the preceding claims,
wherein the magnet apparatus is mechanically connected with the associated measuring tube, and wherein the coil apparatus is translationally as well as rotationally fixed relative to the inlet, and outlet.

15. Coriolis measuring device (1) comprising:
A Coriolis measuring transducer (10) as claimed in one of the preceding claims;
an electronic measuring/operating circuit (77), wherein the electronic measuring/operating circuit is adapted electrically to supply the coils and, in given cases, associated temperature measuring device, wherein the supplying of the coil as well as the temperature measuring device is accomplished by means of separate electrical connections (19) or by means of multiplexing,
wherein the at least one electrical connection (19) of a sensor, or exciter, extends by means of a cable path (20) to the electronic measuring/operating circuit,
wherein the electronic measuring/operating circuit is further adapted to ascertain flow measured values and/or density measurement values, and
wherein the measuring device especially has an electronics housing (80) for housing the electronic measuring/operating circuit.
